(19) United States
(12) Patent Application Publication
(10) Pub. No.: US 2004/0035287 A1
(43) Pub. Date: Feb. 26, 2004

(54) Brake booster for motor vehicle

(76) Inventors: Cedric Leboisne, Paris (FR); Patrice Moinard, Montreuil (FR); Rui Ferreira, Meudon La Foret (FR)

Correspondence Address: Leo H McCormick Jr, 2112 Mishawaka Avenue, PO Box 4721, South Bend, IN, 46634-4721, US

(21) Appl. No.: 10/433,629

(22) PCT Filed: Dec. 3, 2001
(86) PCT No.: PCT/FR01/03808

(30) Foreign Application Priority Data
Dec. 6, 2000 (FR) 00/15943

(51) Int. Cl. F15B 9/10

(52) U.S. Cl. 91/376 R

(57) ABSTRACT

A servomotor for an assisted braking of a motor vehicle comprises a rear wall (20) in which an axial cylindrical shaft (48) is formed, an intermediate part of which exhibits an inner shoulder (56) limiting the axial rearward motion of the piston (28) and capable of resisting a pulling force exerted on the control rod (12) driven by the brake pedal.

This invention relates to a servomotor for the assisted braking of a motor vehicle.

In a well-known manner, such servomotor is installed between a control rod, driven by a brake pedal, and a master cylinder of a braking circuit so as to amplify, or boost, the force exerted on the pedal and transmit it to the piston of the master cylinder, and it comprises a casing divided into a front chamber, which is connected to the engine negative pressure, and a rear chamber, the pressure of which may selectively vary between the engine negative pressure and the atmospheric pressure. The pressure difference between these chambers acts upon a piston, disposed in the casing between the control rod and the piston of the master cylinder.

The control rod is connected to such piston of the servomotor through a flap for the supply control of the rear chamber of the casing, which is fitted inside a rear tubular section of the piston of the servomotor and comprises a cylindrical tubular member, which receives the front end of the control rod, shaped into a toggle.

The rear transverse wall of the casing of the servomotor includes a cylindrically-shaped axial shaft, usually resulting from a stamping process, extending rearwards and comprising a rear flange, which is radially directed towards the axis and constitutes a stop limiting the rearward axial travel of the piston of the servomotor.

When the casing of the servomotor is made of a comparatively thick sheet, e.g. in the order of 1.5 mm, and when the axial length of the shaft is not too great, the thickness of the rear flange of the shaft is able to withstand a pulling force exerted on the control rod which, in the automotive manufacturers' specifications, is set to a value of about 200-250 daN.

If the casing of the servomotor is made of a thinner sheet, more especially when its end transverse walls are rigidly interconnected by tie bars, and when the shaft has a greater axial length, particularly when the master cylinder is slightly shifted axially towards the inside of the servomotor so as to reduce the axial extent of the servomotor/master cylinder assembly in the forward direction, the thickness of the rear flange of the shaft, thus resulting from a stamping operation, is comparatively small, e.g. in the order of 0.4 mm, which means that it can no longer resist a tensile force of about 200-250 daN, applied to the control rod.

Therefore, it is an object of the present invention to provide a simple, efficient and inexpensive solution to the above-mentioned problem.

Another object of the invention consists in coping with said difficulty without having to alter, in an intricate and expensive way, pre-existing servomotor/master cylinder systems.

These objects are achieved in that a servomotor for the assisted braking of a motor vehicle comprises a casing, in which a piston is axially movable by a control rod, which is driven by a brake pedal and the front end of which is fitted in a cylindrical control member inside the piston, a rear cylindrical tubular section of which is guided in a tight manner within a cylindrical shaft provided at the casing, characterised in that axial-retaining means for the piston, which limit the rearward motion of the latter, are constituted by an intermediate part of the shaft.

When the shaft is fabricated out of a stamped thin sheet, like that of a casing provided with tie bars of the above-described type, its thickness in the middle area is still capable of withstanding a tensile force in the range from 200 to 250 daN, exerted on the control rod, even though the length of the shaft may have been increased in order to take into account a rearward shifting of the master cylinder in relation to the servomotor.

In a preferred embodiment of the present invention, the axial-retaining means for the piston consist of an inner shoulder provided in the shaft, connecting a reduced-diameter rear part with a front part of the shaft.

The servomotor piston comprises, at its rear section, means intended to cooperate with the axial-retaining means provided in the shaft.

Advantageously, an annular ring is placed between the axial-retaining means, provided in the shaft, and the matching means on the piston.

Such annular ring acts like a radial distance piece between the means situated on the piston and those provided in the shaft, thus reducing to a minimum the alterations which have to be made in standard shafts and pistons.

Other features, details and advantages of the present invention will be apparent from the following detailed description, when taken in conjunction with the accompanying drawings, in which:

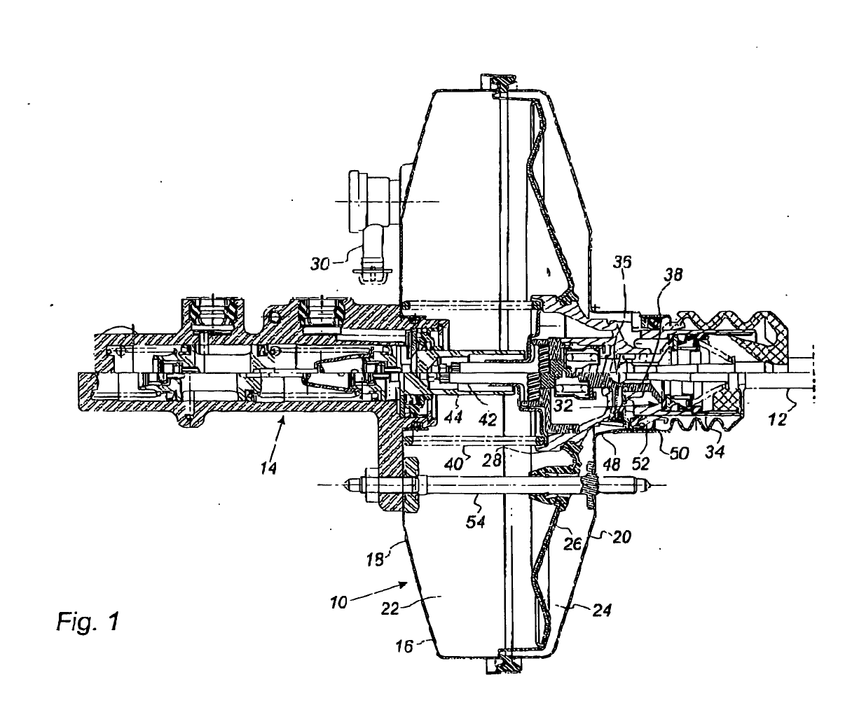

FIG. 1 is a schematic axial sectional view of a servomotor/master cylinder assembly, showing in the lower half-part a known assembly according to the prior art while the upper half-part represents an assembly according to the present invention; and

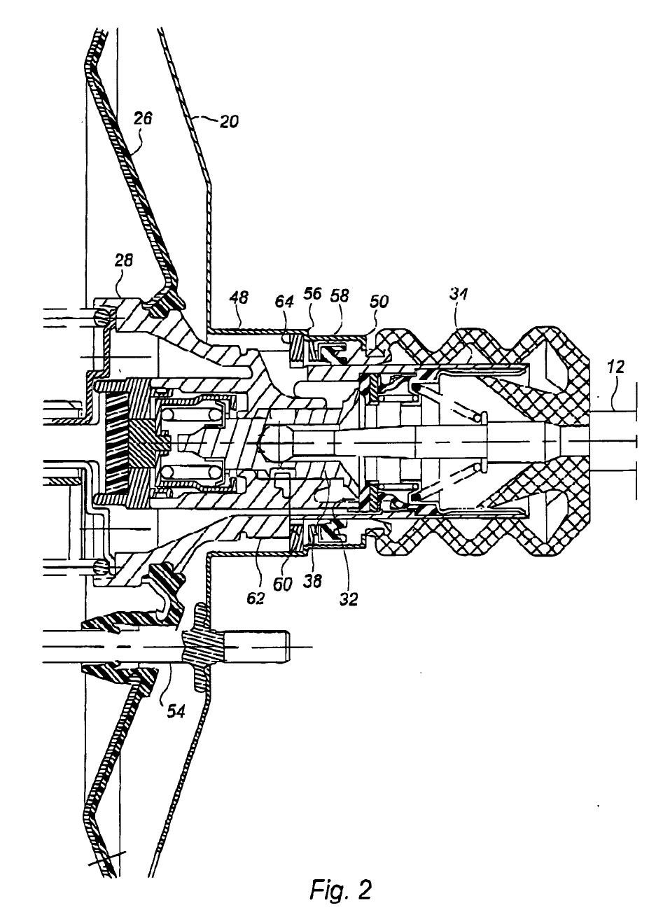

FIG. 2 is a schematic axial sectional view on a larger scale of the rear section of a servomotor according to the present invention.

As a rule, in the following description, the front art and the rear part will refer to elements or positions respectively facing leftward and rightward in the drawings.

In FIG. 1, a pneumatic servomotor for an assisted braking, referred to as 10, is associated, on the one hand, with a brake pedal (not shown) by a control rod 12 and, on the other hand, with a master cylinder 14 of a hydraulic braking circuit.

The servomotor 10 comprises a substantially cylindrical casing 16, consisting of a front annular wall 18 and a rear annular wall 20, assembled facing each other and fastened at their outer peripheries in a tight manner, such casing being divided into a front chamber 22 and a rear chamber 24 in a leakproof manner by an inner annular partition wall 26 extending radially inside the casing 16, between its outer periphery and a central piston 28, axially displaceable inside the casing 16 by means of the control rod 12.

The front chamber 22 is connected, by an adapter 30, to a vacuum source, for instance the engine negative pressure in the case of a gasoline engine, or a vacuum pump if the vehicle has a Diesel engine. In a well-known manner, the pressure inside the rear chamber 24 is controlled using a flap system 32, fitted within the rear section 34 of the piston 28, such rear section 34 exhibiting a tubular cylindrical shape and extending axially rearwards.

The flap system 32 is actuated by the front end of the control rod 12, said front end, in the form of a toggle 36, being received within a cylindrical control member 38, guided inside the piston 28 for an axial sliding motion.

At the front side, the piston 28 is associated with a return spring 40, arranged between its front end and the front annular wall 18 of the casing 16, so as to bias the piston 28 permanently in the rearward direction. The front end of the piston 28 is also connected, by means of a push rod 42, to a primary piston 44 of the master cylinder 14.

In such a known arrangement, the forward axial travel of the control rod 12, driven by the brake pedal, results in a forward motion of the piston 28, which is transmitted to the primary piston 44 of the master cylinder 14 so as to supply a braking circuit with pressure hydraulic fluid. The moving force imparted to the piston 28 by the control rod 12 is amplified through the pressure difference between the chambers 22 and 24 of the servomotor, the front chamber 22 being connected to the engine negative pressure while the flap system 32 causes the pressure within the rear chamber 24 to vary between the engine negative pressure and the atmospheric pressure, as a function of the travels of the control rod 12.

In the lower half-part of FIG. 1, showing a known assembly according to the prior art, the rear wall 20 of the casing 16 of the servomotor comprises a substantially cylindrical shaft 48, extending axially rearwards and having a rear flange 50, extending radially towards the axis and constituting retaining means which restrict the rearward axial motion of the piston 28, through sealing and guiding means 52 for the piston 28.

In order to comply with specifications, given by automotive manufacturers, such rear end flange 50 must resist a pulling or tensile force in the order of 200-250 daN, which is applied to the control rod 12 in the rearward direction and transferred to the flange 50 through the control member 38 and the piston 28.

The shaft 48 is fabricated through a stamping process carried out on the central area of the rear wall 20 and its thickness is gradually decreasing from its front end to its rear end. When the wall 20 is made of a comparatively thick sheet, e.g. in the order of 1.5 mm, and when the axial length of the shaft is not too great, the thickness of the rear flange 50 of the shaft amounts to about 0.9 mm and it is able to withstand the above-mentioned pulling force in the range from 200 to 250 daN. On the other hand, if the casing 10 of the servomotor is made of a thinner sheet, more especially when its end transverse walls are rigidly interconnected by tie bars 54, as shown in FIG. 1 in a schematic manner, the thickness of the rear flange 50 of the shaft 48 may be below 0.4 mm, which means that it generally is no longer capable of resisting said pulling force.

Such phenomenon grows worse when, in order to reduce the axial extent of the assembly, consisting of the servomotor 10 and the master cylinder 14, in the forward direction, the master cylinder is somewhat shifted rearwards towards the inside of the casing 16, as shown in the upper part of FIG. 1. As a matter of fact, such an offset of the master cylinder rearwards results in that the locations of the flap system 32 and of the control member 38 have to be displaced rearwards too, and therefore the axial length of the shaft 48 must be increased, as illustrated in the upper part of FIG. 1. Such an axial lengthening of the shaft 48 means a further thinning down of the radial flange 50, which is no longer able to resist the above-mentioned pulling force.

In order to cope with such a difficulty, as is schematically shown in the upper part of FIG. 1 and more clearly in FIG. 2, the invention makes provision for an inner shoulder 56, situated in an intermediate or substantially median part of the shaft 48, such inner shoulder joining up a reduced-diameter rear part 58 of the shaft with a front part of the shaft.

Said inner shoulder 56 of the shaft is intended to cooperate, in an abutting way, with appropriate means 60 provided on the outer peripheral surface of the piston 28, for instance a shoulder 60 connecting the rear tubular cylindrical section 34 of the piston with a larger-diameter intermediate cylindrical section 62 of said piston.

Advantageously, an annular ring or washer 64 is placed between the shoulder 56 of the shaft 48 and the shoulder 60 of the piston 28, inside the shaft 48 and about the piston 28, such annular ring having an outer diameter which is substantially equal to, or just slightly smaller than, the inner diameter of the front part of the shaft 48, and an inner diameter which is smaller than the outer diameter of the shoulder 60 provided on the piston 28.

This being so, the shoulder 56 of the shaft 48 acts as an axial-retaining means for the piston, whereas, in the known embodiment of the device according to the prior art as shown in the lower part of FIG. 1, it is the rear flange 50 of the shaft which actually serves this purpose. This shoulder 56, situated in an intermediate part of the shaft 48, is thicker than the rear flange 50 and, therefore, it is able to withstand said pulling force, even though the rear wall 20 of the casing 16 may have a comparatively small thickness, e.g. about 0.8 mm.

Thanks to an appropriate selection of its inner diameter and of its axial thickness, the annular ring 64 makes it possible to adjust the diameter and the axial position of the shoulder 56 of the shaft to the diameter and the axial position of the shoulder 60 of the piston 28.

Just like the prior art, the shaft 48 of the servomotor according to this invention may comprise a rear flange 50 so that sealing and guiding means for the cylindrical tubular section 34 of the piston 28 may be kept in position. Yet, such rear flange 50 is no longer designed to resist a high pulling or tensile force exerted on the control rod 12, since said force is now taken by the intermediate shoulder 56 of the shaft.

Thus, through simple and inexpensive means, including the forming of the shoulder 56 in the course of the stamping process as concerns the shaft 48, and the optional placement of the annular ring 64, the present invention solves the problem of the resistance to a pulling or tensile force exerted on the control rod 12, when the casing 16 of the servomotor is made of a thin sheet and when the master cylinder has been installed slightly farther rearwards in the casing 16 in order to reduce the axial extent in the forward direction.

The present invention concerns, more particularly, the motor car industry and it mainly applies to the design and manufacturing of motor vehicle braking systems, especially for private cars.

1. A servomotor for the assisted braking of a motor vehicle, comprising a casing (16), in which a piston (28) is axially movable by a control rod (12), which is driven by a brake pedal and the front end (36) of which is fitted in a control member (38) inside the piston (28), a rear cylindrical tubular section (34) of which is guided in a tight manner within a cylindrical shaft (48) provided at the casing (16), characterised in that axial-retaining means (56) for the piston (28), which limit the rearward motion of the latter, are constituted by an intermediate part of the shaft (48).

2. The servomotor according to claim 1, characterised in that the axial-retaining means for the piston (28) consist of an inner shoulder (56) provided in the shaft, connecting a front part with a reduced-diameter rear part (58) of the shaft.

3. The servomotor according to claim 1, characterised in that the outer peripheral surface of the piston (28) comprises means intended to cooperate with said axial-retaining means (56) provided at the shaft (48).

4. The servomotor according to claim 3, characterised in that said means provided on the piston (28) consist of a shoulder (60) at its outer surface, connecting a reduced-diameter rear section with a front section.

5. The servomotor according to claim 4, characterised in that an annular ring (64) is placed between the axial-retaining means (56), provided at the shaft, and the matching means (60) on the piston.

6. The servomotor according to claim 3, characterised in that the shaft (48) is formed by means of a stamping operation carried out on a rear wall (20) of the servomotor casing.

7. The servomotor according to claim 3, characterised in that the end walls (18, 20) of the servomotor casing (16) are rigidly interconnected by tie bars (54).

8. The servomotor according to claim 3, characterised in that it is associated with a master cylinder (14) extending axially in part inside said casing (16), in order to reduce the axial extent of the assembly, consisting of the servomotor (10) and the master cylinder (14), in the forward direction.
